(19) United States
(12) Patent Application Publication
(10) Pub. No.: US 2013/0339860 A1
(43) Pub. Date: Dec. 19, 2013

(54) ASSISTING USERS WITH PRESENTING DATA USING CINEMATIC TECHNIQUES

(71) Applicants: Vijay Mital, Kirkland, WA (US); Suraj T. Poozhiyil, Redmond, WA (US); Darryl Rubin, Duvall, WA (US); Amir Netz, Bellevue, WA (US); Olivier Colle, Bellevue, WA (US); Andrew Douglas Reddish, Redmond, WA (US)

(72) Inventors: Vijay Mital, Kirkland, WA (US); Suraj T. Poozhiyil, Redmond, WA (US); Darryl Rubin, Duvall, WA (US); Amir Netz, Bellevue, WA (US); Olivier Colle, Bellevue, WA (US); Andrew Douglas Reddish, Redmond, WA (US); Christian Beaumont, Seattle, WA (US)

(73) Assignee: MICROSOFT CORPORATION, Redmond, WA (US)

(21) Appl. No.: 13/517,516

(22) Filed: Jun. 13, 2012

(51) Int. Cl. G06F 3/0484

(52) U.S. Cl. CPC G06F 3/0484
USPC 715/730

(57) ABSTRACT

The present invention extends to methods, systems, and computer program products for assisting users with presenting data using cinematic techniques. Embodiments of the invention can be used to infer and generate cinematic techniques or combinations thereof based on a model and user action. Cinematic techniques can be used to meet the data exploration and analysis requirements of a user. As such, embodiments of the invention assist users (including non-programmers) to employ cinematic techniques (possibly in combination with other techniques) to gain insights into their data and also convey appropriate emotional messages.

### CROSS-REFERENCE TO RELATED APPLICATIONS

Not Applicable.

### BACKGROUND

### Background and Relevant Art

Computer systems and related technology affect many aspects of society. Indeed, the computer system's ability to process information has transformed the way we live and work. Computer systems now commonly perform a host of tasks (e.g., word processing, scheduling, accounting, etc.) that prior to the advent of the computer system were performed manually. More recently, computer systems have been coupled to one another and to other electronic devices to form both wired and wireless computer networks over which the computer systems and other electronic devices can transfer electronic data. Accordingly, the performance of many computing tasks is distributed across a number of different computer systems and/or a number of different computing environments.

Users can gain or share insight on their data through visualizations like charts, graphs, maps and hierarchies. These visualizations have simple and commonly used mechanisms using object color (hues, saturation and transparency), text (font families and styles) and visibility to emphasize, denote selection and highlight insights for exploring and analyzing the underlying data. In some environments, due at least in part to their simplicity, these visualizations make it difficult for users to effectively gain/share insights about their data. In turn, it is also difficult to convey an appropriate emotional message and have a highly interactive user experience.

### BRIEF SUMMARY

The present invention extends to methods, systems, and computer program products for assisting users with presenting data using cinematic techniques. A user desired message for presenting a portion of data is accessed. The portion of data has meaning based on data values contained in the portion of data. One or more cinematic techniques are suggested for presenting data in a manner that conveys the user desired message. The one or more cinematic techniques correspond to one or more of: camera position, lighting, movement, and transitions.

A user selection, for using at least one of the one or more suggested cinematic techniques when presenting the portion of data, is received. The portion of data is presented at a display device to convey the user desired message. The user desired message is conveyed by presenting the values contained in the portion of data in accordance with the selected at least one suggested cinematic technique.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computer architecture that facilitates assisting users with presenting data using cinematic techniques.

FIG. 2 illustrates a flow chart of an example method for assisting users with presenting data using cinematic techniques.

### DETAILED DESCRIPTION

The present invention extends to methods, systems, and computer program products for assisting users with presenting data using cinematic techniques. A user desired message for presenting a portion of data is accessed. The portion of data has meaning based on data values contained in the portion of data. One or more cinematic techniques are suggested for presenting data in a manner that conveys the user desired message. The one or more cinematic techniques correspond to one or more of: camera position, lighting, movement, and transitions.

A user selection, for using at least one of the one or more suggested cinematic techniques when presenting the portion of data, is received. The portion of data is presented at a display device to convey the user desired message. The user desired message is conveyed by presenting the values contained in the portion of data in accordance with the selected at least one suggested cinematic technique.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, embodiments of the invention can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

In this description and the in the following claims, “cinematic techniques” are defined as techniques used in cinematography. Cinematic techniques can relate to camera position, camera angle, lighting, movement, transitions, sound, expression (depth and perspective), etc. Cinematic techniques can include: cross-cutting, jump cutting, continuity cuts, match cuts, deep focus, eye-line matching, different shots (close-up, medium, long shot, tilt, aerial, etc.), fade ins, fade outs, flashbacks, focus, iris in/iris out, key lighting, master shots, medium shots, montages, panning, point of view shots, pull back shots, reverse angles, tracking, zooming, backlighting, fill lighting, flood lighting, mood lighting, soft lighting, diegetic sound, non-diegetic sound, etc. A variety of other cinematic techniques can also be used.

In some embodiments, cinematic techniques are arranged in a taxonomy, such as, for example, a hierarchical structure of one or more trees. A root node for each tree can represent a cinematic technique (e.g., camera movement techniques) and lower level nodes can represent different implementations (e.g., pan, zoom, track, etc.) of the cinematic technique. A taxonomy of cinematic techniques can be a separate data structure or can be codified into a data presentation module.

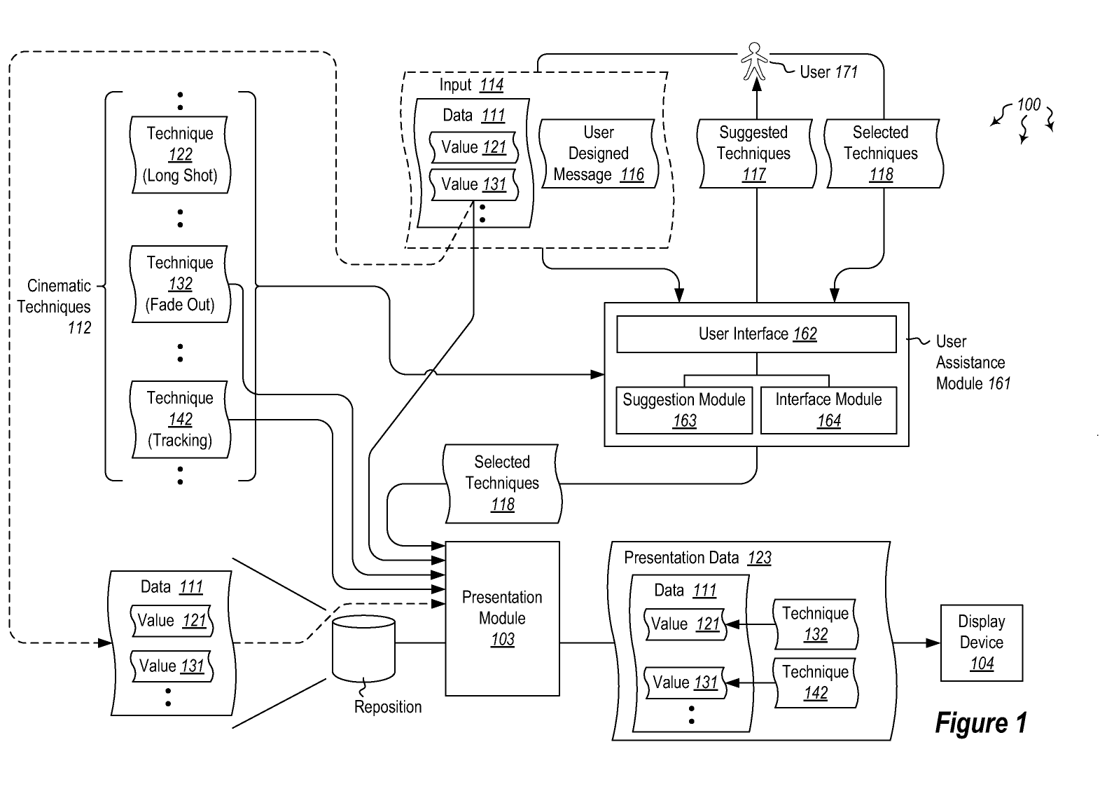

FIG. 1 illustrates an example computer architecture 100 that facilitates assisting users with presenting data using cinematic techniques. Referring to FIG. 1, computer architecture 100 includes user assistance module 161, presentation module 103, display device 104, and repository 107. Each of the depicted components is connected to one another over (or is part of) a network, such as, for example, a Local Area Network (“LAN”), a Wide Area Network (“WAN”), and even the Internet. Accordingly, each of the depicted components as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over the network.

Generally, repository 107 stores data, such as, for example, data for user 121. Stored data can have values that give meaning to data. For example, the stored data can be sales figures. Thus, values for part numbers, sales percentages, revenues, descriptions, addresses, etc., within the stored data can give meaning to how well various items are selling.

Presentation module 103 is configured to receive a portion of stored and/or entered data and selected cinematic techniques. The selected cinematic techniques can indicate a user desired message to convey when presenting the portion of data. Based on selected cinematic techniques, presentation module 103 can present data to convey a user desired message. Cinematic techniques can be identified and/or selected from within cinematic techniques 112. In some embodiments, cinematic techniques within cinematic techniques 112 are arranged in a cinematic technique taxonomy.

Presentation module 103 can formulate presentation data for presenting the stored and/or entered data at a display device to convey the user desired message. The user desired message can be conveyed by presenting values from the stored data in accordance with the identified cinematic techniques. Presentation module 103 can send presentation data to a display device.

As depicted, user assistance module 161 includes user interface 162, suggestion module 163, and inference module 164. User interface 162 provides an interface to receive input from and present output to a user (e.g., user 171). Inference module 164 can infer more concrete user presentation requirements from a more abstract user desired message. A user desired message can be, for example, an emotional message, such as, happy, sad, professional, upbeat, sarcastic, etc. A user desired message can the use of visual objects/properties. User presentation requirements can be more concrete requirements that relate or represent the emotional message.

Based on inferred user presentation requirements, suggestion module 163 can identity suggested cinematic techniques from cinematic techniques 112. The suggested cinematic techniques can be cinematic techniques that when applied to a portion of accessed and/or entered data convey (or at least approximate) the user desired message.

User interface 162 can send suggested cinematic techniques to a user. The user can select one or more suggested cinematic techniques for use with an accessed and/or entered portion of data. User assistance module 161 can send the selected cinematic techniques to presentation module 103. Presentation module 103 can receive the selected cinematic techniques from user assistance module 161. Presentation module 103 can use the selected cinematic techniques to generate presentation data and send the presentation to a display device.

Display device 104 is configured to receive presentation data. Display device 104 can display the presentation data in accordance with identified and/or selected cinematic techniques to convey a user desired message.

In some embodiments, presentation module 103, display device 104, and user assistance module 161 are components of the same computer system. Thus, it may be that both user interface 162 and presentation data from presentation module 103 is presented at display device 104.

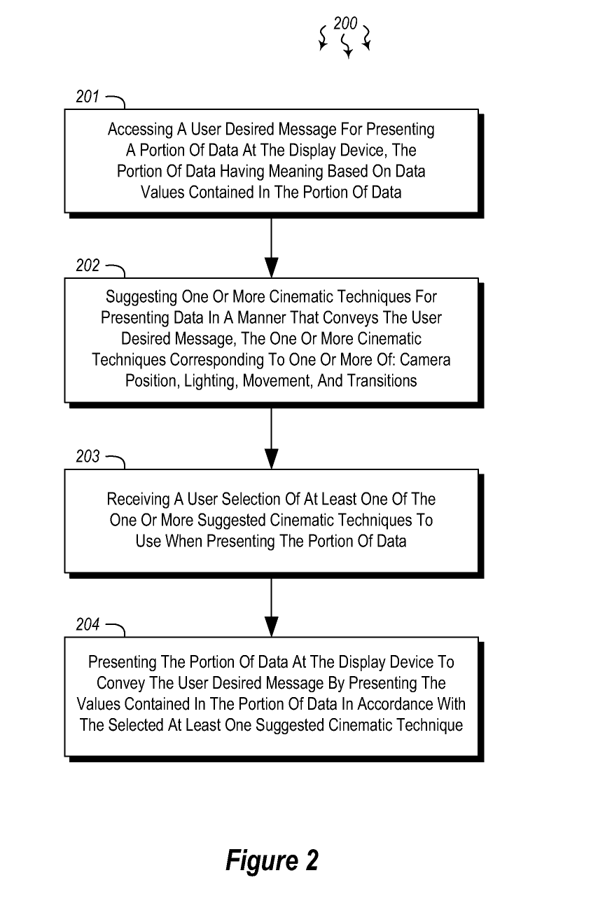

FIG. 2 illustrates a flow chart of an example method 200 for assisting users with presenting data using cinematic techniques. Method 200 will be described with respect to the components and data of computer architecture 100.

Method 200 includes an act of accessing a user desired message for presenting a portion of data at the display device, the portion of data having meaning based on data values contained in the portion of data (act 201). For example, user 171 can enter input 114 into user interface 162. As depicted, input 114 includes user desired message 116. Input 114 can also include and/or identify data 111. For example, data 111 may have previously been stored in repository 107. Alternately, data 111 can be sent to presentation module 103 (and/or repository 107) in combination with user desired message 116 being sent to user assistance module 161. Data 111 has meaning based on values 121, 131, etc. (e.g., addresses, names, numbers, etc.) in data 111.

Method 200 includes an act of suggesting one or more cinematic techniques for presenting data in a manner that conveys the user desired message, the one or more cinematic techniques corresponding to one or more of: camera position, lighting, movement, and transitions (act 202). For example, user assistance module 161 can suggest suggested techniques 117 (e.g., technique 122 (long shot), technique 132 (fade out), and technique 142 (tracking)) to user 171. When applied, suggested cinematic techniques 117 can present data 111 in a manner that conveys user desired message 116. Inference module 164 can infer user presentation requirements from user desired message 116. Suggestion module 163 can access cinematic techniques 112 and select suggested techniques 117 from cinematic techniques 112 based on the inferred user presentation requirements.

In some embodiments, cinematic techniques 112 include one or more different combinations of cinematic techniques that can be used to fully convey user desired message 116. In these embodiments, suggestion module 162 can suggest at least one of the different combinations to user 171. In other embodiments, cinematic techniques 112 does not include a combination of cinematic techniques that can be used to fully convey user desired message 116. In these other embodiments, suggestion module 162 can suggest a combination of cinematic techniques to user 171 that approximates user desired message 116 to the extent possible.

Method 200 includes an act of receiving a user selection of at least one of the one or more suggested cinematic techniques to use when presenting the portion of data (act 203). For example, user 171 can select selected techniques 118 (e.g., technique 132 (fade out) and technique 142 (tracking)) to use when presenting data 111. User 171 can send selected techniques 118 to user assistance module 161. User assistance module 161 can receive selected techniques 118 from user 171. Selected techniques 118 can include at least one of suggested techniques 117. User 171 can also supplement selected techniques with other techniques in addition to those included in suggested techniques 117. As such, user 171 can customize cinematic techniques used to presented data 111 so as to convey user desired message 116 as appropriate.

Method 200 includes an act of presenting the portion of data at the display device to convey the user desired message by presenting the values contained in the portion of data in accordance with the selected at least one suggested cinematic technique (act 204). For example, user assistance module 161 can send selected techniques 118 to presentation module 103. Subsequently, presentation module 103 can formulate presentation data 123 for presenting data 111 in accordance with techniques 132 and 142. Presentation module 103 can send presentation data 123 to display device 104. Presentation data 123 can be presented at display device 104. As such, data 111 can be presented at display device 104 to convey (or at least approximate) user desired message 116 by presenting values 121, 131, etc., in accordance with techniques 122 and 142.

In some embodiments, cinematic techniques, such as, for example, cinematic techniques 112, are arranged in a cinematic technique hierarchy. The cinematic technique hierarchy includes camera position techniques, camera movement techniques, transition techniques, and lighting techniques. Camera position techniques further include tilt, close up, and long shot. Clouse up further includes medium close up and extreme close up.

Camera movement techniques include pan, track, and zoom. Pan further includes left (representing panning left) and right (representing panning right). Whip pan represents that either left or right panning can be in the form of a whip pan. Transition techniques include cut and flashback. Cut further includes match cut and jump cut. Lighting techniques include flood lighting, key lighting, and lens flare.

Cinematic techniques for presenting data can be selected from intermediate or leaf locations for a technique. For less specificity, higher level locations in the cinematic technique hierarchy can be selected. On the other hand, lower level locations in the cinematic technique hierarchy provide more specificity for a cinematic technique. For example, if panning is identified, the direction or type of panning may not matter when conveying a user desired message. As such, a pan can be selected. Pan can correspond to a default speed and direction of panning. On the other hand, there may additional user meaning in panning to the right. Thus, right can be selected. Right can correspond to panning at a default speed to the right.

In some embodiments, data visualizations are associated with visualization metadata. The visualization metadata can indicate visual objects or properties to which data can be bound. The visualization metadata can also indicate ways in which visual objects or properties can be changed (e.g., scaled, transformed, re-colored, etc.). The visualization metadata can also indicate the constraints on values that a visual object or property can take (e.g., aesthetic rules, rules or proportion, etc).

Data metadata can be used to describe the shape of data. The data metadata can indicate whether data continuous values, or discrete, or small set of enumerable discrete values, whether there are ranges, whether there is some geometric implication (e.g. location or physical design or coordinates), etc. Data metadata can also indicate relationships within sets, such as, for example, whether it's a list of peer values or of alternatives and whether outliers can be discarded. Data metadata can also indicate whether the data is meaningfully sampleable/quantizable/smoothable.

In these embodiments, presentation module 103 and/or user assistance module can include logic for identifying and applying appropriate cinematic techniques. Presentation module 103 and/or user assistance module can go through visualization metadata and data metadata. Presentation module 103 and/or user assistance module 161 can identify sets of visual objects/properties, mappings of visual objects/properties to elements of data, and the relationships between visual objects/properties and elements of data. Presentation module 103 can then identify the cinematic techniques or combinations thereof based on above relationships. Presentation module 103 and/or user assistance module 161 can generate multiple choices of ‘styles’, apply one as the default, and show a user the ‘effect’ of applying this technique. However, not all the styles generated, nor all the available combinations, need be proposed for applying to a particular choice set).

Other data presentation techniques, such as, for example, charts, graphs, maps, hierarchies, etc. can be used along with cinematic techniques. These other data presentation techniques can use object color (hues, saturation, and transparency), text (font families and styles), and visibility to assist with exploring and analyzing data.

Accordingly, embodiments of the invention can be used to infer and generate cinematic techniques or combinations thereof based on a model and user action. Cinematic techniques can be used to meet the data exploration and analysis requirements of a user. As such, embodiments of the invention assist users (including non-programmers) to employ cinematic techniques (possibly in combination with other techniques) to gain insights into their data and also convey appropriate emotional messages.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. At a computer system including one or more processors and system memory, the computer system also including a display device, a computer-implemented method for assisting a user with presenting data using cinematic techniques, the method comprising:
an act of accessing a user desired message for presenting a portion of data at the display device, the portion of data having meaning based on data values contained in the portion of data;
an act of suggesting one or more cinematic techniques to a user, the one or more cinematic techniques for presenting data in a manner that conveys the user desired message, the one or more cinematic techniques corresponding to one or more of: camera position, lighting, movement, and transitions;
an act of receiving a user selection of at least one of the one or more suggested cinematic techniques to use when presenting the portion of data; and
an act of presenting the portion of data at the display device to convey the user desired message by presenting the values contained in the portion of data in accordance with the selected at least one suggested cinematic technique.

2. The method as recited in claim 1, wherein the act of suggesting one or more cinematic techniques to a user comprises an act of suggesting a panning technique for presenting data in a manner that conveys the user desired message.

3. The method as recited in claim 1, wherein the act of suggesting one or more cinematic techniques to a user comprises an act of suggesting a cutting technique for presenting data in a manner that conveys the user desired message.

4. The method as recited in claim 1, wherein the act of suggesting one or more cinematic techniques to a user comprises an act of identifying a fading technique for presenting data in a manner that conveys the user desired message.

5. The method as recited in claim 1, wherein the act of suggesting one or more cinematic techniques to a user desired message comprises:
an act of inferring infer user presentation requirements from the accessed user desired message; and
an act of identifying the one or more a cinematic techniques based on the inferred user presentation requirements.

6. The method as recited in claim 1, wherein the act of suggesting one or more cinematic techniques to a user comprises an act of suggesting one or more cinematic techniques from within a taxonomy of cinematic techniques.

7. The method as recited in claim 1, wherein the act of presenting the portion of data at the display device to convey the user desired message comprises an act of using other presentation techniques along with the selected at least one suggested cinematic technique to convey the user desired message.

8. The method as recited in claim 1, wherein the act of presenting the portion of data at the display device to convey the user desired message comprises an act of presenting the portion of data to aid in data exploration of a data repository.

9. A computer program product for use at a computer system, the computer system including a data repository and display device, the computer program product for implementation a method for assisting a user with presenting data using cinematic techniques, the computer program comprising one or more computer storage devices having stored thereon computer-executable instructions that, when executed at a processor, cause the computer system to perform the method, including the following:
access a user desired message for presenting a portion of data at the display device, the portion of data having meaning based on data values contained in the portion of data;
suggest one or more cinematic techniques for presenting data in a manner that conveys the user desired message, the one or more cinematic techniques corresponding to one or more of: camera position, lighting, movement, and transitions;
receive a user selection of at least one of the one or more suggested cinematic techniques to use when presenting the portion of data; and
present the portion of data at the display device to convey the user desired message by presenting the values contained in the portion of data in accordance with the selected at least one suggested cinematic technique.

10. The computer program product as recited in claim 9, wherein computer-executable instructions that, when executed, cause the computer system to suggest one or more cinematic techniques for presenting data in a manner that conveys the user desired message comprise computer-executable instructions that, when executed, cause the computer system to suggest one or more of: a panning technique, a cutting technique, and a fading technique, for presenting data in a manner that conveys the user desired message

11. The computer program product as recited in claim 9, wherein computer-executable instructions that, when executed, cause the computer system to suggest one or more cinematic techniques for presenting data in a manner that conveys the user desired message comprise computer-executable instructions that, when executed, cause the computer system to
infer user presentation requirements from the accessed user desired message; and
identify the one or more a cinematic techniques based on the inferred user presentation requirements.

12. The computer program product as recited in claim 9, wherein computer-executable instructions that, when executed, cause the computer system to suggest one or more cinematic techniques for presenting data in a manner that conveys the user desired message comprise computer-executable instructions that, when executed, cause the computer system to suggest one or more cinematic techniques from within a taxonomy of cinematic techniques.

13. A computer system, the computer system including:
one or more processors;
system memory;
a data repository, the data repository storing data; and
one or more computer storage media having stored there on computer-executable instructions representing a user assistance module and a presentation module, the user assistance module configured to:
access a user desired message for presenting a portion of data at the display device, the portion of data having meaning based on data values contained in the portion of data;
suggest one or more cinematic techniques for presenting data in a manner that conveys the user desired message, the one or more cinematic techniques corresponding to one or more of: camera position, lighting, movement, and transitions; and
receive a user selection of at least one of the one or more suggested cinematic techniques to use when presenting the portion of data; and
wherein the user assistance module configured to:
present the portion of data at the display device to convey the user desired message by presenting the values contained in the portion of data in accordance with the selected at least one suggested cinematic technique.

14. The method as recited in claim 13, wherein the user assistance module configured to suggest one or more cinematic techniques for presenting data in a manner that conveys the user desired message comprises the user assistance module being configured to suggest a panning technique for presenting data in a manner that conveys the user desired message.

15. The method as recited in claim 13, wherein the user assistance module configured to suggest one or more cinematic techniques for presenting data in a manner that conveys the user desired message comprises the user assistance module being configured to suggest a cutting technique for presenting data in a manner that conveys the user desired message.

16. The method as recited in claim 13, wherein the user assistance module configured to suggest one or more cinematic techniques for presenting data in a manner that conveys the user desired message comprises the user assistance module being configured to suggest a fading technique for presenting data in a manner that conveys the user desired message.

17. The method as recited in claim 13, wherein the user assistance module configured to identify one or more cinematic techniques for presenting data in a manner that conveys the user desired message comprises the user assistance module being configured to:
infer user presentation requirements from the accessed user desired message; and
identify the one or more a cinematic techniques based on the inferred user presentation requirements.

18. The method as recited in claim 13, wherein the user assistance module configured to suggest one or more cinematic techniques for presenting data in a manner that conveys the user desired message comprises the user assistance module being configured to suggest the one or more cinematic techniques from within a taxonomy of cinematic techniques.

19. The method as recited in claim 13, wherein the presentation module configured to present the portion of data at the display device to convey the user desired message comprises the presentation module being configured to use other presentation techniques along with the selected at least one suggested cinematic technique cinematic techniques to convey the user desired message.

20. The method as recited in claim 13, wherein the presentation module configured to present the portion of data at the display device to convey the user desired message comprises the presentation module being configured to present the portion of data to aid in exploring the data stored in the data repository.
